(19) United States
(12) Patent Application Publication
(10) Pub. No.: US 2015/0028021 A1
(43) Pub. Date: Jan. 29, 2015

(54) METHOD FOR PROCESSING A MODULAR HYBRID COMPONENT

(71) Applicant: ALSTOM Technology Ltd, Baden (CH)

(72) Inventors: Daniel BECKEL, Wettingen (CH); Alexander Stankowski, Wuerenlingen (CH); Sophie Betty Claire Duval, Zuerich (CH)

(21) Appl. No.: 14/496,485

(22) Filed: Sep. 25, 2014

Related U.S. Application Data
(63) Continuation of application No. PCT/EP2013/056148, filed on Mar. 22, 2013.

(30) Foreign Application Priority Data
Mar. 28, 2012 (EP) 12161875.5

(51) Int. Cl. B23K 1/00; B23K 1/19; B23K 1/002

(52) U.S. Cl. CPC B23K 1/0018; B23K 1/002; B23K 1/19
USPC 219/615; 219/616

(57) ABSTRACT

The invention relates to a method for processing a modular hybrid component having a first part made of a first material and a second part made of a second material, which is different from the first material with regard to its electromagnetic and/or thermal properties. The method including exposing the modular hybrid component to an alternating electromagnetic field, whereby both parts are heated up differently, and that a brazing or soldering joint or field sensitive mineral cement between the first part and the second part is affected by the heating action.

### CROSS-REFERENCE TO RELATED APPLICATIONS

This application claims priority to PCT/EP2013/056148 filed Mar. 22, 2013, which claims priority to European application 12161875.5 filed Mar. 28, 2012, both of which are hereby incorporated in their entireties.

### TECHINICAL FIELD

The present invention relates to modular hybrid components in the field of gas turbine technology. It refers to a method for processing a modular hybrid component according to the preamble of claim 1.

### BACKGROUND

Modern, next generation gas turbine hot gas path components consist of more than one material (see for example EP 1 362 983 A2, US 2010/0166551 A1, EP 2 017 433 A2, EP 2 108 785 A2, US 2010/0074759 A1 or U.S. Pat. No. 7,452,189 B2) to adjust the properties of each region of the component to its environment.

Very often those parts consist of ceramic and metal sections to make use of the higher temperature capability of the ceramic where needed and of the strength/and/or toughness of the metal where needed.

After completion of one service interval, the components need to be disassembled and worn pieces need to be replaced. Typically the ceramic part cannot be reworked and will be replaced, while the metal part can be reused or reworked (e.g. crack brazing). Such modular parts are often joined together by brazing (see US 2008/0056888 A1, US 2008/0307793 A1).

Limited information is available on disassembly of modular parts. US 2008/0229567 A1 discloses a process that intends to leach out only a ceramic matrix in which ceramic fibres are embedded and to restore the ceramic afterwards by infiltration. However, the leaching process is not disclosed. Furthermore, the leaching process would only be suitable for a local repair of the ceramic part, which is very unlikely considering the brittle behaviour of ceramics and does not take advantages of the modular design of the component, which aims at replacing worn pieces instead of doing repair, which anyway can only cope with limited damages.

Especially, when considering multiple reconditioning or heavy damages of gas turbine parts, a disassembly is unavoidable. Thus, although US 2008/0229567 A1 provides a process that is beneficial for some niche applications, it does not solve the problem of how to efficiently remove the ceramic part from the metallic part.

Another process known in the art for disassembling of brazed parts is de-brazing, i.e. subjecting the entire component to high temperatures in a furnace in order to re-melt the braze alloy. However, this requires temperatures exceeding the original braze temperature, since the melting point depressants have diffused during service operation and thus the liquidus temperature of the braze joint has increased.

Therefore, the metal part component is prone to thermal deterioration. In addition, the braze alloy is only re-melt but not dissolved, i.e. residues are still attached to the joining surfaces even if the parts can be separated. However, these joining surfaces have complicated geometries and tight tolerances, so that every mechanical cleaning of the joining surfaces risks modifying their geometry beyond the tolerance.

The U.S. Pat. No. 6,054,693 discloses a method enabling controlled selective heating of workpiece components during microwave brazing. Two workpiece components are joined by melting an adhesion interlayer material between the two components. An indication of when the interlayer has melted is provided. The temperature difference across the braze assembly is monitored and adjusted via a feedback loop to reduce stresses in the braze joint resulting in a stronger braze joint.

### SUMMARY

It is an object of the present invention to provide a method for processing a modular hybrid component in order so disassemble or assemble said component, wherein either one part is not substantially affected and can thus be reused after disassembly or a low stress joint with better quality is achieved.

These and other objects are obtained by a method according to claim 1.

The inventive method for processing a modular hybrid component comprising a first part made of a first material and a second part made of a second material, which is different from said first material with regard to its electromagnetic and/or thermal properties, is characterized in that said modular hybrid component is exposed to an alternating electromagnetic field, whereby both parts are heated up differently, and that a brazing or soldering joint or field sensitive mineral cement between said first part and said second part is affected by said heating action.

According to an embodiment of the invention said first part is a metal part and said second part is a ceramic part, and said alternating electromagnetic field has a frequency of more than 1 kHz.

Specifically, said alternating electromagnetic field has a frequency of more than 1 GHz.

According to another embodiment of the invention said electromagnetic field is confined in a chamber in a multimode configuration.

Specifically, an atmosphere exists in said chamber during execution of the process, which atmosphere contains less than ambient oxygen partial pressure.

More specifically, the total pressure in said chamber during execution of the process is less than 1 mbar, specifically less than 10⁻⁴ mbar.

According to a further embodiment of the invention said chamber contains an atmosphere, which is inert or reducing.

According to another embodiment of the invention said brazing or soldering joint connects said first and second part and that said heating process leads to at least a softening of the brazing or soldering joint between said two parts.

Specifically, the brazing or soldering joint between said two parts softens or melts, such that the two parts can be separated.

According to a further embodiment of the invention said first and second part are arranged adjacent to but separate from each other, a brazing or soldering material is provided between said first and second part, and said heating process leads to a melting of said brazing or soldering material, such that, upon cooling, a solid joint layer is formed between said first and second part.

With the disclosed selective heating of the ceramic part (which is more temperature tolerant than the metal and is anyway replaced during service/repair in most cases), the metal part is not substantially affected and can thus be reused after de-brazing or de-cementing by selective heat input.

Furthermore, the disclosed joining of the dissimilar parts leads to a low stress joint by selectively heating preferably the ceramic section during brazing and thus offers a better quality (reduced inherent stresses in joint due to less CTE (Coefficient of Thermal Expansion) mismatch when joining parts 1 and 2).

### BRIEF DESCRIPTION OF THE DRAWINGS

The present invention is now to be explained more closely by means of different embodiments and with reference to the attached drawings.

FIG. 1 shows different steps in a method for separating the ceramic part from the metal part of a hybrid metal/ceramic component being exposed in a chamber to microwave radiation according to an embodiment of the invention and

FIG. 2 shows different steps in a method for joining (during re-assembly or manufacturing) the ceramic part and the metal part of a hybrid metal/ceramic component being exposed in a chamber to microwave radiation according to another embodiment of the invention.

### DETAILED DESCRIPTION

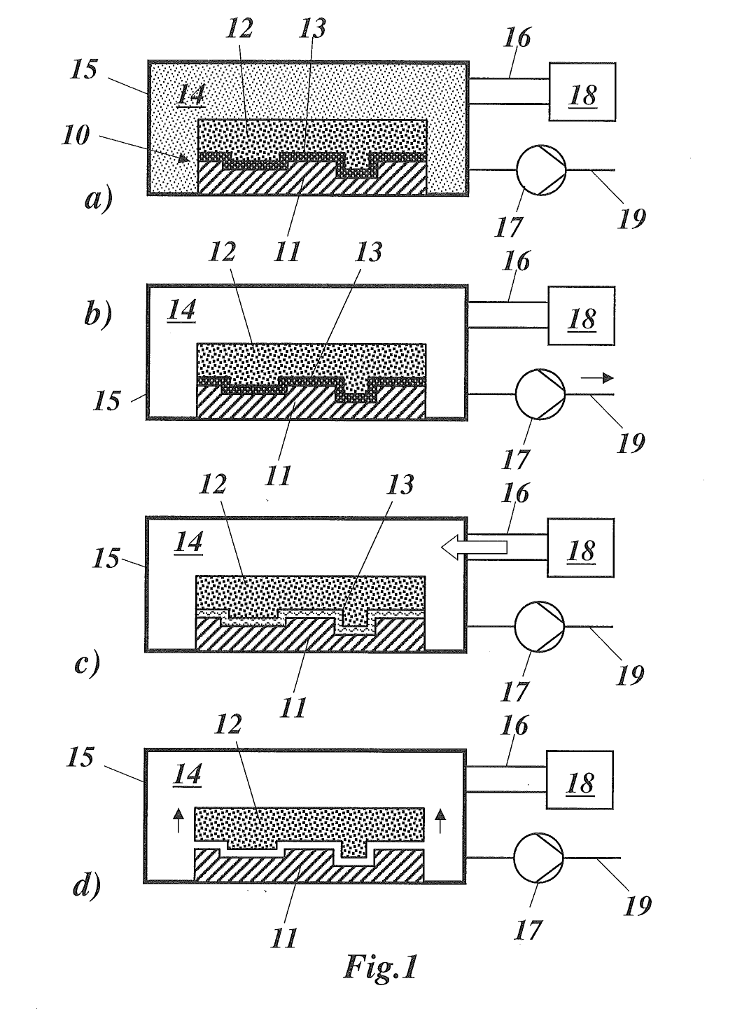

FIG. 1 shows different steps in a method for separating the ceramic part 12 from the metal part 11 of a hybrid metal/ceramic component 10 being exposed in a chamber 15 to microwave radiation according to an embodiment of the invention.

The process starts with a component 10, which comprises a metal part 11, which is joined with a ceramic part 12 by means of a joint layer 13 (FIG. 1(a)).

The component 10 is put into a chamber 15, in which a microwave radiation field can be established by means of a microwave source 18, which is connected to the chamber 15 by microwave line 16. The inner space 14 of the chamber 15 can be pumped out or evacuated by means of pump 17 through a pumping line 19.

After being evacuated (FIG. 1(b)), the inner space 14 of the chamber 15 with the hybrid component 10 is subjected to microwave radiation emitted by the microwave source 18 (FIG. 1(c)).

The microwave radiation results in a selective heating of the ceramic part 12, which leads to a melting of the joint layer 13, such that the metal part 11 and ceramic part 12 are finally separated (FIG. 1(d)).

### 1. Example

Disassembly of a modular hybrid part, having a ceramic airfoil manufactured from CMC (Ceramic Matrix Composite) with a high SiC content that is attached to a load carrying metallic spar and a platform (both manufactured from superalloys) by brazing
Aim: remove the damaged ceramic airfoil, without deterioration of the superalloy platform and spar;
Process: the part is subjected to a 2.45 GHz multimode microwave in high vacuum (<10⁻⁴ mbar);
Result: due to the strong coupling of the SiC with the microwave, a strong heating of the SiC occurs, while the bulk metal is mainly heated by conduction from the SiC through the braze joint and thus significantly colder. The braze joint melts due to the heat conduction from the SiC and can thus be separated. The heat input received from the metal is not sufficient to affect the microstructure of the superalloy; thus the superalloy can be reused.

### 2. Example

Removal of ceramic tiles consisting of YSZ from a combustor liner fabricated from a superalloy:
Aim: remove the worn tiles, without deterioration of the superalloy liner;
Process: the part is subjected to a 2.45 GHz multimode microwave in high vacuum (<10⁻⁴ mbar);
Result: due to the stronger coupling of the YSZ with the microwave, a strong heating of the YSZ occurs, while the bulk metal is mainly heated by conduction from the YSZ through the braze joint and thus significantly colder. The braze joint melts due to the heat conduction from the YSZ and can thus be separated. The heat input received from the metal is not sufficient to affect the microstructure of the superalloy, thus the superalloy can be reused.

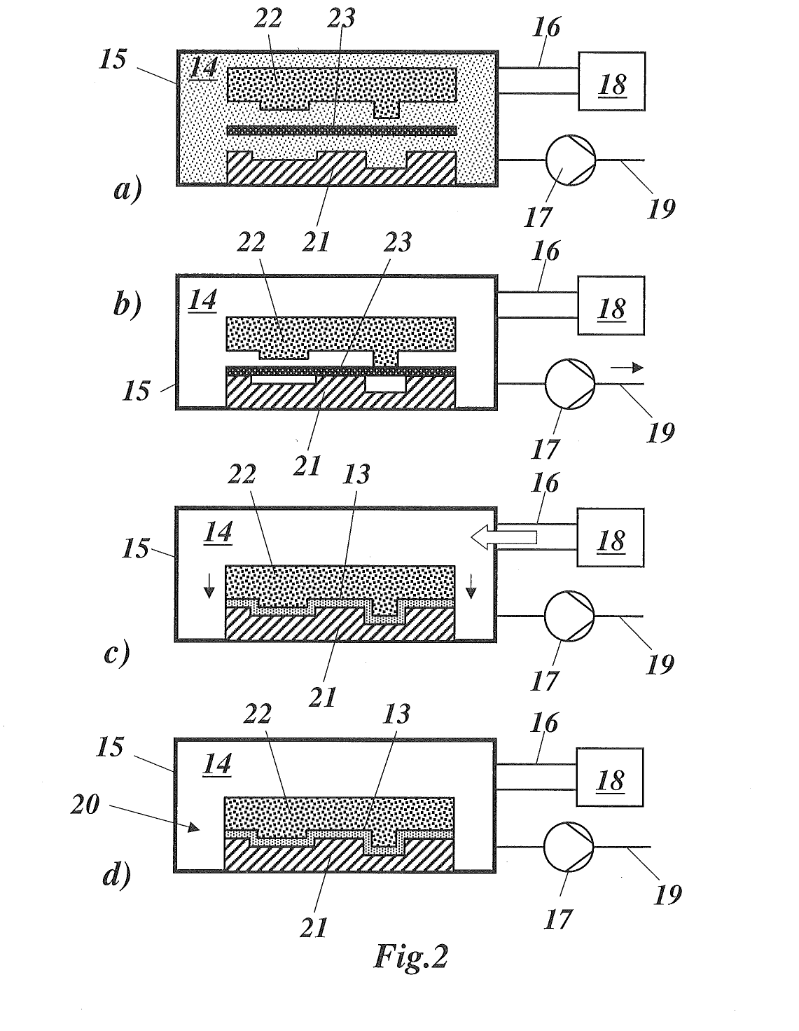

FIG. 2 shows different steps in a method for joining a ceramic part and a metal part of a hybrid metal/ceramic component being exposed in a chamber to microwave radiation according to another embodiment of the invention.

The process starts with a two separate parts of a component 20, which comprise a metal part 21, which is to be joined with a ceramic part 22 by means of a joint layer.

The parts 21 and 22 of the component 20 are put into a chamber 15, in which a microwave radiation field can be established by means of a microwave source 18, which is connected to the chamber 15 by microwave line 16. The inner space 14 of the chamber 15 can be pumped out or evacuated by means of pump 17 through a pumping line 19. The parts 21 and 21 are arranged adjacent to each other with a brazing foil 23 put in between (FIG. 2(a)).

After being evacuated (FIG. 2(b)), the inner space 14 of the chamber 15 with the parts arrangement 21, 22, 23 is subjected to microwave radiation emitted by the microwave source 18 (FIG. 2(c)).

The microwave radiation results in a selective heating of the ceramic part 22, which leads to a melting of the brazing foil 23, such that the metal part 11 and ceramic part 12 are finally joined by means of a joint layer 13 (FIG. 2(d)).

### 3. Example

Joining of a new CMC airfoil with high SiC content to the metallic spar and platform recovered in example:
Aim: braze ceramic airfoil to superalloy spar and platform, without causing cracks or excessive stress in the joint, although both materials have a different thermal expansion coefficient;
Process: a brazing foil is applied on the interface between ceramic and superalloy and the part is subjected to a 2.45 GHz multimode microwave in high vacuum (<10⁻⁴ mbar);
Result: due to the strong coupling of the SiC with the microwave, a strong heating of the SIC occurs, while the bulk metal is mainly heated by conduction from the SiC through the brazing foil and thus significantly colder. The brazing foil melts due to the heat conduction from the SiC and thus joins both parts. The joint is crack-free and shows a low stress level, since the least expanding material (ceramic) was heated most. Thus, upon cooling the overall shrinkage of the ceramic and superalloy is similar in dimension.

Thus, the process of reconditioning of modular gas turbine hot gas path parts that consist of metallic and ceramic components or different ceramic components, is improved, whereby only one part is removed by the described de-brazing process and a new part is joined by the described joining process.

1. A method for processing a modular hybrid component having a first part made of a first material and a second part made of a second material, which is different from said first material with regard to its electromagnetic and/or thermal properties; said method comprising said modular hybrid component being exposed to an alternating electromagnetic field, whereby both parts are heated up differently, and that a brazing or soldering joint or field sensitive mineral cement between said first part and said second part is affected by said heating action.

2. The method according to claim 1, wherein said first part is a metal part and said second part is a ceramic part, and said alternating electromagnetic field has a frequency of more than 1 kHz.

3. The method according to claim 2, wherein said alternating electromagnetic field has a frequency of more than 1 GHz.

4. The method according to claim 1, wherein said electromagnetic field is confined in a chamber in a multimode configuration.

5. The method according to claim 4, wherein that an atmosphere exists in said chamber during execution of the process, which atmosphere contains less than ambient oxygen partial pressure.

6. The method according to claim 5, wherein the total pressure in said chamber during execution of the process is less than 1 mbar, specifically less than 10⁻⁴ mbar.

7. The method according to claim 1, wherein said chamber contains an atmosphere, which is inert or, reducing.

8. The method according to claim 1, wherein said brazing or soldering joint and mineral cement connects said first and second part and that said heating process leads to at least a softening of the brazing or soldering joint between said two parts.

9. The method according to claim 8, wherein the brazing or soldering joint between said two parts softens or melts, such that the two parts can be separated.

10. The method according to claim 1, wherein said first and second part are arranged adjacent to but separate from each other, that a brazing or soldering material is provided between said first and second part, and that said heating process leads to a melting of said brazing or soldering material, such that, upon cooling, a solid low stress joint layer is formed between said first and second part.
